(19) United States
(12) Patent Application Publication
(10) Pub. No.: US 2014/0211689 A1
(43) Pub. Date: Jul. 31, 2014

(54) Slow-Fading Precoding for Multi-Cell Wireless Systems

(71) Applicant: Alcatel-Lucent USA Inc., Murray Hill, NJ (US)

(72) Inventors: Alexei Ashikhmin, Morristown, NJ (US); Thomas L. Marzetta, Summit, NJ (US)

(73) Assignee: Alcatel-Lucent USA Inc., Murray Hill, NJ (US)

(21) Appl. No.: 13/751,470

(22) Filed: Jan. 28, 2013

(51) Int. Cl. H04B 7/04

(52) U.S. Cl. CPC H04B 7/0456
USPC 370/328

(57) ABSTRACT

Methods and apparatuses for slow-fading precoding for multi-cell wireless systems are provided. At a base station of a cellular network, the base station serving a pluralities of same-cell terminals and other-cell terminals, and the cellular network including other base stations that serve respective pluralities of same-cell terminals and other-cell terminals, a plurality of slow-fading coefficients are obtained, wherein each of the plurality of slow-fading coefficients is associated with channel state information for communication between one of the other base stations and one of the respective same-cell terminals or other-cell terminals. A set of slow-fading precoding coefficients are generated for transmitting signals to same-cell terminals and other-cell terminals based on the plurality of slow-fading coefficients.

### TECHNICAL FIELD

The present disclosure is generally directed to wireless communication systems that use multiple antennas to achieve improved network performance.

### BACKGROUND

It has long been known that techniques of spatial multiplexing can be used to improve the spectral efficiency of wireless networks. (Spectral efficiency describes the transmitted data rate per unit of frequency, typically in bits per second per Hz.) In typical examples of spatial multiplexing, a multiple array of transmit antennas sends a superposition of messages to a multiple array of receive antennas. The channel state information (CSI), i.e., the channel coefficients between the respective transmit-receive antenna pairs, is assumed known. Provided that there is low correlation among the respective channel coefficients, the CSI can be used by the transmitter, or the receiver, or both, to define a quasi-independent channel for each of the transmitted messages. As a consequence, the individual messages are recoverable at the receiving antenna array.

More recently, experts have proposed extensions of the spatial multiplexing technique, in which a multiplicity of mobile or stationary user terminals (referred to herein as “terminals”) are served simultaneously in the same time-frequency slots by an even larger number of base station antennas or the like, which we refer to herein as “service antennas”, or simply as “antennas”. Particularly when the number of service antennas is much greater than the number of terminals, such networks may be referred to as “Large-Scale Antenna Systems” (LSAS).

Theoretical studies predict that the performance of LSAS networks scales favorably with increasing numbers of service antennas. In particular, there are gains not only in the spectral efficiency, but also in the energy efficiency. (The energy efficiency describes the ratio of total data throughput to total transmitted power, and is measured, e.g., in bits per Joule.)

One such study is T. L. Marzetta, “Noncooperative Cellular Wireless with Unlimited Numbers of Base Station Antennas,” IEEE Trans. on Wireless Communications 9 (November 2010) 3590-3600, hereinafter referred to as “Marzetta 2010”.

In some approaches, the base stations may obtain CSI through a procedure that relies on time-division duplex (TDD) reciprocity. That is, terminals send pilot sequences on the reverse link, from which the base stations can estimate the CSI. The base stations can then use the CSI for beam-forming. This approach works well when each terminal can be assigned one of a set of mutually orthogonal pilot sequences.

Generally, it is considered advantageous for the terminals to synchronously transmit all pilot sequences on a given frequency, and possibly even on all frequencies, making use of the mutual orthogonality of the pilot sequences.

The number of available orthogonal pilot sequences, however, is relatively small, and can be no more than the ratio of the coherence time (an interval during which prevailing channel conditions between a base station and a terminal are assumed to be static) to the delay spread (the difference between the time of arrival of the earliest significant multipath component and the time of arrival of the latest multipath component). Terminals within a single cell can use orthogonal pilot sequences, but terminals from the neighboring cells will typically be required to reuse at least some of the same pilot sequences. This reuse of pilot sequences in different cells creates the problem of pilot contamination. The pilot contamination causes a base station to beam-form its message-bearing signals not only to the terminals located in the same cell, but also to terminals located in the neighboring cells. This phenomenon is known as directed interference. The directed interference does not vanish as the number of base station antennas increases. In fact, the directed inter-cell interference—along with the desired signals—grows in proportion to the number of base station antennas.

As shown in Marzetta 2010, for example, as the number of base station antennas grows in an LSAS network, inter-cell interference arising from pilot contamination will eventually emerge as the dominant source of interference.

What has been lacking, until now, is an approach that can suppress this inter-cell interference and thus achieve even greater signal to interference and noise ratios (SINRs, or singularly, SINR). Frequency reuse schemes exist for mitigating directed inter-cell interference, such as where the available frequency band is partitioned, for example, into three sub-bands and cells are partitioned into three types A, B and C. In such schemes, type A cells may use a first transmission sub-band, type B cells may use a second transmission sub-band, type C cells may use a third transmission sub-band, etc., where in theory cells of different types do not create inter-cell interference to each other. However, a disadvantage of this approach is that each base station may only transmit within a designated sub-band, thereby potentially limiting data transmission rates.

### SUMMARY

Methods and apparatuses for slow fading pre-coding for multi-cell wireless systems are provided. In accordance with an embodiment, at a base station of a cellular network in which a plurality of terminals are served, the base station serving a plurality of same-cell terminals and other-cell terminals, and the cellular network including other base stations that serve respective pluralities of same-cell terminals and other-cell terminals, a plurality of slow-fading coefficients are obtained, wherein each of the plurality of slow-fading coefficients is associated with channel state information for communication between one of the other base stations and one of the respective same-cell terminals or other-cell terminals, and a set of slow-fading precoding coefficients are generated for transmitting signals to same-cell terminals and other-cell terminals based on the plurality of slow-fading coefficients.

In accordance with an embodiment, the set of slow-fading precoding coefficients are generated by performing an iterative function to determine optimized slow-fading precoding coefficients. Each optimized slow-fading precoding coefficient is determined based on maximizing a minimum signal to interference and noise ratio for transmitting a signal to same-cell terminals and other-cell terminals. The iterative function may include a quasi-convex optimization algorithm and may be terminated based on a precision control threshold.

In accordance with an embodiment, pilot signals may be obtained from the plurality of terminals, and signals may be beam-formed to one or more of the plurality of same-cell terminals and other-cell terminals based on the set of slow-fading precoding coefficients. The beam-forming may be based on a set of fast-fading coefficients and may be performed using OFDM modulation.

In accordance with an embodiment, the set of slow-fading precoding coefficients may be transmitted to one of the other base stations or to a processing center module.

These and other advantages of the invention will be apparent to those of ordinary skill in the art by reference to the following detailed description and the accompanying drawings.

### BRIEF DESCRIPTION OF THE DRAWINGS

FIG. 1 is a schematic drawing of a portion of an LSAS network, illustrating inter-cell interference due to pilot contamination;

FIG. 2 is a schematic drawing of a portion of an LSAS network, illustrating a distinction between fast-fading coefficients and slow-fading coefficients;

FIG. 3 is a schematic drawing illustrating channel vectors between a base station and an other-cell terminal in accordance with an embodiment; and

FIG. 4 illustrates a flow diagram for determining an optimal slow-fading precoding coefficient in in accordance with an embodiment.

FIG. 5 is a high-level block diagram of a base station apparatus that may be used for determining an optimal slow-fading precoding coefficient aⱼ^{[k]}.

### DETAILED DESCRIPTION

In accordance with the various embodiments, a message-carrying signal transmitted from a base station antenna array during one channel use interval is referred to here as a “symbol”. A symbol is distributed in space and frequency, because each base station has multiple antennas for transmission, and because each symbol will typically be distributed over multiple OFDM subcarriers or “tones”.

The term “antenna” refers to a base station antenna associated with a cell. Each cell has at most M antennas. The term “terminal” refers to a static or mobile user terminal.

The total number of cells is L. Each cell contains at most K terminals. The total number of pilot signals is K. The pilot signals are numbered 1, . . . , K. The pilot signals are assumed to be allocated to terminals such that in each cell, the k-th terminal is allocated pilot signal k.

Antenna mj is the m-th antenna of cell j. Terminal kl is the k-th terminal of cell l.

For tone n, the channel coefficient between antenna mj and terminal kl is gₙₘⱼ^{[kl]}. Hereinafter, the tone index n will be suppressed from our notation. An M×K channel matrix Gⱼₗ is defined between the base station of cell j and the terminals of cell l by:

[Gⱼₗ]ₘ_{₁}ₖ_{₁}=gₙₘⱼ^{[kl]}; m=m₁, k=k₁. (1)

The channel coefficient g may be factored into a fast-fading factor h and a slow-fading factor β^{1/2}:

gₙₘⱼ^{[kl]}=hₙₘⱼ^{[kl]}·(βⱼ^{[kl]})^{1/2}.

The h coefficients, which represent fast-fading, can change with as little as ¼ wavelength of motion. On the other hand, the fading behavior represented by the β coefficients, is slowly varying. Although the β coefficients (i.e., the slow-fading coefficients) are often referred to as “shadow” fading coefficients, this fading is typically a combination of geometric attenuation and shadow fading. Typically, it is constant over frequency and slowly varying over space and time. By contrast, fast-fading typically changes rapidly over space and time. In frequency, fast-fading varies over frequency intervals that are the reciprocal of the channel delay spread. Without loss of generality in the mathematical analysis below, the assumption can be made that the h coefficients have unit variance (because the multiplicative decomposition of g is non-unique).

As referred to above, the slow-fading coefficient β has been indexed for the base station of cell j and the k-th terminal of cell l. It has not been indexed for an individual antenna of the base station of cell j because these coefficients are assumed quasi-independent of spatial location, at least on the spatial scale of an antenna array.

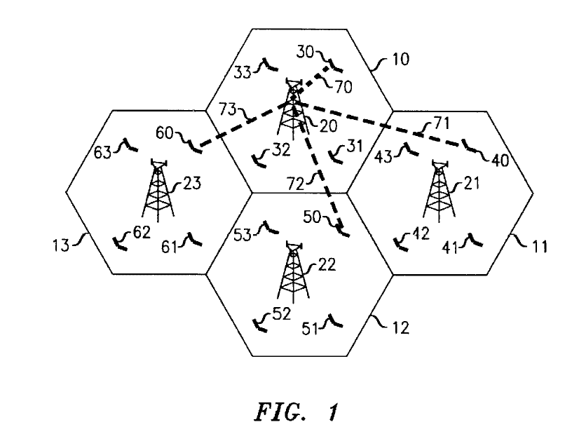

FIG. 1 is a schematic drawing of a portion of an LSAS network, illustrating inter-cell interference due to pilot contamination. FIG. 1 shows a portion of a cellular network, including cells 10-13, having respective base stations 20-23. A plurality of mobile terminals is shown in each cell, respectively labeled 30-33, 40-43, 50-53, and 60-63. To simplify the drawing, each of the base stations is treated as having only a single antenna.

In forward-link transmission, base station 20, for example, transmits a message to terminals 30 on path 70. If terminals 40, 50, and 60 have been assigned the same pilot signal as terminal 30, pilot contamination may cause the transmitted message to interfere on paths 71, 72, and 73 to terminals 40, 50, and 60, respectively.

Conversely, in reverse-link transmission, terminal 30 transmits a message to base station 20 on path 70. (For purposes of this illustration, we are treating paths 70-73 as bidirectional.) Pilot contamination may cause the reverse-link messages on paths 71-73 to interfere, at base station 20, with the reverse-link message transmitted from terminal 30 on path 70.

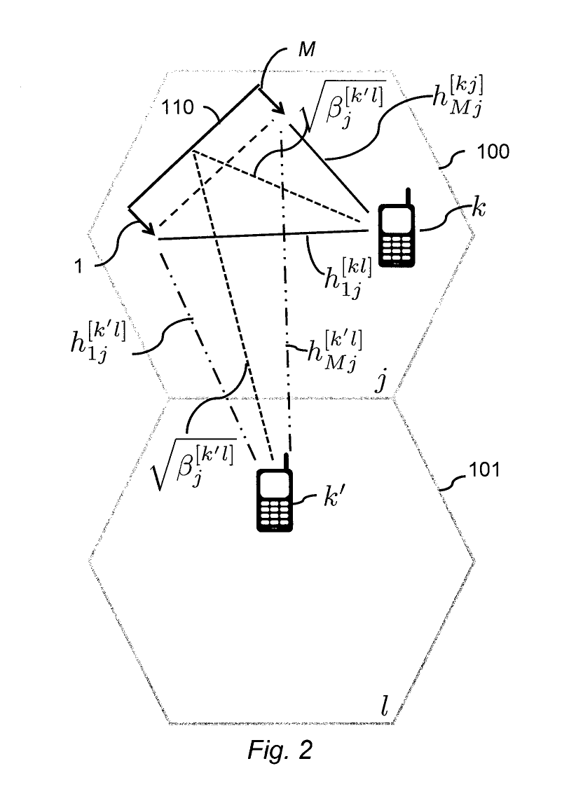

FIG. 2 is a schematic drawing of a portion of an LSAS network, illustrating a distinction between fast-fading coefficients and slow-fading coefficients. FIG. 2 shows a portion of a cellular network, including cells 100 and 101. To illustrate what is meant by fast-fading and slow-fading coefficients, the figure includes base station antenna array 110 of cell 100, mobile terminal k of cell 100, and mobile terminal k′ of cell 101. To simplify the figure, all other features of the cells have been omitted. As indicated in the figure, cell 100 is cell j for purposes of this illustration, and cell 101 is cell l. Antenna array 110 includes M antennas, of which antenna 1 and antenna M have been explicitly shown. Although antenna array 110 has been drawn, for convenience, as a linear array, it should be noted that there is no requirement for the geographical distribution of antennas to take a linear shape, or any other particular shape. Likewise, the scale of the linear antenna array has been drawn, solely for convenience, as comparable to the size of the cell. There is no limitation on the geographical scale of the antenna array, except that it will generally be advantageous to space the antennas apart by at least one-half wavelength to minimize the electromagnetic coupling between antennas.

In FIG. 2, propagation paths from antenna 1 to terminal k, antenna 1 to terminal k′, antenna M to terminal k, and antenna M to terminal k′ have been respectively labeled with the fast-fading coefficients h₁ⱼ^{[kj]}, h₁ⱼ^{[k′j]}, h_{Mj}^{[kj]}, and h_{Mj}^{[k′j]}. Two slow-fading coefficients are also indicated. They are \sqrt{βⱼ^{[kl]}} from antenna array 110 to terminal k of cell j, and \sqrt{βⱼ^{[k′l}]} from antenna array 110 to terminal k′ of cell l. Other fast-fading coefficients from intermediate antennas of array 110 to the respective terminals are indicated only by broken lines.

In the following discussion, OFDM signal modulation is assumed to be used for both forward link and reverse link signals. It should be understood, however, that the embodiments herein are not limited to OFDM, but may be implemented using other modulation techniques such as time-reversal modulation or CDMA modulation.

In a time-division duplexing multi-cell wireless network (also referred to herein as a TDD network, or simply as a network), each cell includes a base station. Each base station is equipped with M antennas, and terminals are equipped with one antenna each. The number of base station antennas M is typically relatively large, as the performance of multi-cell wireless networks typically grows proportionally with the number of antennas. For example, the number of antennas M may be between 20 to 1000 antennas or more.

A coherence interval T defines an interval during which prevailing channel conditions between base stations and mobile terminals are assumed to be static (i.e., the channel conditions do not change). For example, in high-level downlink transmission protocol terminals in all cells may synchronously send pilot sequences. The pilot sequences propagate to all antennas of all base stations. Each base station uses these pilot sequences to estimate CSI (channel vectors) between each of its antenna and in-cell mobile terminals. Each estimated CSI value will be assumed to be valid for the duration of a coherence interval. The base stations then may use their CSI estimates to synchronously beam-form signals to the terminals located within their cells (i.e., to same-cell terminals).

The beam-forming technique significantly reduces interference between signals sent to different terminals. For example, in each cell there may be K terminals (K same-cell terminals) enumerated by integers 1, . . . , K. The K terminals may employ K unique pilot sequences for communication with base stations. Likewise, terminals in different cells (i.e., other-cell terminals) may use the same set of K orthogonal pilot sequences r₁, . . . , rₖ, rᵢ*rⱼ=0. As such, in each cell the k-th terminal will communicate via the pilot sequence rₖ .

Current TDD networks may achieve data uplink and downlink transmission rates that are significantly higher than in LTE systems. However, various issues inherent in such systems have until now prevented further increases in data transmission rates. These issues include: (1) directed inter-cell interference caused by pilot contamination, (2) channel estimation error, (3) non-orthogonal channel vectors, and (4) beam-forming gain uncertainty at terminals.

Directed inter-cell interference caused by pilot contamination describes a condition caused by terminal pilot sequences. Typically, pilot sequences are relatively short, since terminals can move fast throughout a network. A consequence of short pilot sequences is that the number of orthogonal sequences is small. Therefore, a network may not include enough orthogonal pilot sequences for all terminals, e.g., for other-cell terminals from an in-cell base station perspective. In practice, pilot contamination can result from the unavoidable use non-orthogonal pilot sequences. Because of pilot contamination, inter-cell interference may not disappear even if the number of base stations antennas M tends to infinity.

Channel estimation error describes an instance where a base station estimates CSI with an error. As typical pilot sequences are relatively short, channel estimation errors can be significant. In practice, a base station that beam-forms signals including a channel estimation error can result in interference within the network.

When the number of base station antennas M tends to infinity, the CSI, that is the channel vectors gⱼ^{[kl]}=(g₁ⱼ^{[kl]}, g₂ⱼ^{[kl]}, . . . , g_{Mj}^{[kl]}), gⱼ^{[k′l′} =(g_{1j′}^{[k′l′]}, g₂ⱼ^{[k′l′]}, . . . , g_{Mj}^{[k′l′]}), (j, k, l)≠(j′, k′, l′), between base stations and different terminals generally becomes mutually orthogonal (i.e. lim_{M→∞}gⱼ^{[kl]}*gⱼ^{[k′l′]}=0, thus allowing for the avoidance of downlink interference. In reality, however, when the number of base station antennas M is finite, the channel vectors are non-orthogonal and can cause network interference.

Beam-forming gain uncertainty results from when a terminal does not have accurate information regarding the effective channel gain between itself and its in-cell base station. As a result, the terminal can only estimate the channel gain. The estimation error can reduce the SINR achieved during communications with the terminal.

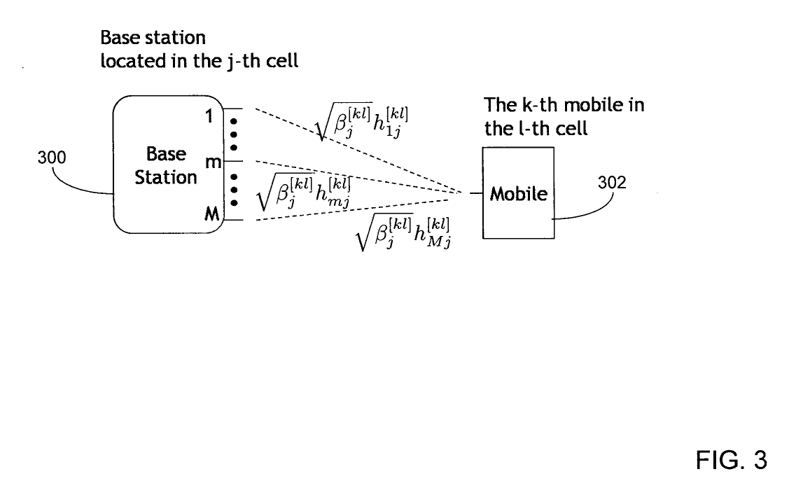

FIG. 3 is a schematic drawing illustrating channel vectors between a base station and an other-cell terminal in accordance with an embodiment. Channel vectors (CSI) are shown between the j-th cell base station 300 (also referred to herein as base station j) and the k-th terminal 302 located in the l-th cell. When a signal propagates from terminal 302 to the m-th antenna of base station 300, it is multiplied by the coefficient \sqrt{βⱼ^{[kl]}}hₘⱼ^{[kl]}. Downlink and uplink reciprocity can be assumed, so when a signal propagates from the m-th antenna of base station j 300 to the k-th mobile terminal 302, the signal is multiplied by the same coefficient \sqrt{βⱼ^{[kl]}}hₘⱼ^{[kl]}.

The coefficient βⱼ^{[kl]} is a slow-fading coefficient. βⱼ^{[kl]} is a real number that changes relatively slowly. In general, the slow-fading coefficient is the same for all antennas of base station j, and is the same for all frequencies of an OFDM channel.

The coefficient hₘⱼ^{[kl]} is a fast-fading coefficient. Unlike the slow-fading coefficient, the fast-fading coefficient can change as soon as a (mobile) terminal moves for ¼ of a wavelength. Further, the fast-fading coefficient is a complex number that depends on an antenna index (e.g., each of the M antennas can have its own fast-fading coefficient), and on the particular frequency of an OFDM channel. As such, fast-fading coefficients are difficult to estimate, and the number of fast-fading coefficients in a practical network will be very large. Indeed, the number of fast-fading coefficients at each base station is equal MKN, where K is the number of terminals within a given cell, and N is the number of frequency bins (frequencies) in the OFDM channel.

In contrast, slow-fading coefficients do not depend on an antenna index or the particular frequency of an OFDM channel. Rather, each base station has only K slow-fading coefficients corresponding to the number of in-cell terminals.

As such, in an embodiment neighboring base stations exchange slow-fading coefficients with each other, and data transmitted to terminals located in a j-th cell is also obtained by base stations in all neighboring cells. Further, base stations may determine slow-fading precoding coefficients such that beam-formed signals can take into account the slow-fading coefficients of neighboring base stations.

A communication protocol in accordance with an embodiment can be considered mathematically wherein T is the length of the coherence interval described above. Pilot sequences can be described as τ-tuples, e.g., any pilot sequence rₖ=(rₖₗ, rₖ₂, . . . , r_{kτ}). The notation ρᵣ is the transmit power of a terminal. For example, all terminals may be assumed to have the same transmit power. The notation ρ_{f} is the transmit power of a base station (e.g., all base stations may be assumed to have the same transmit power).

The notation hⱼ^{[kl]}=(h₁ⱼ^{[kl]}, h₂ⱼ^{[kl]}, . . . , h_{Mj}^{[kl]}) is the fast-fading channel vector between the j-th base station 300 and the k-th terminal 302 located within the l-th cell (as shown in FIG. 3).

The notation gⱼ^{[kl]}=\sqrt{βⱼ^{[kl]}}hⱼ^{[kl]} is the channel vector, which includes both slow-fading βⱼ^{[kl]} and fast-fading coefficients hₘⱼ^{[kl]}.

The notation s^{[kj]} is the signal data for transmission to the k-th terminal located in the j-th cell, and L is the total number of cells in the network. Alternatively, L may be equal to the number of neighboring cells only. However, solely for the sake of descriptive clarity, the entire network can be assumed to include L cells.

In an embodiment, each base station is adapted to estimate its slow-fading coefficients βⱼ^{[kl]} and track the evolution of slow-fading coefficients. Base stations are further adapted to transmit their slow-fading coefficients βⱼ^{[kl]} to neighboring base stations. As such, when all terminals synchronously send their pilots sequences, the pilots sequences propagate to all base stations including the j-th base station, which receives at its M antennas them M×τ complex matrix:

$${Z}_{j} = \sqrt{{ρ}_{t}} {\sum }_{k = 1}^{K} {\sum }_{l = 1}^{L} \sqrt{{β}_{j}^{[ kl ]}} {h}_{j}^{[ kl ]} {r}_{k}^{T} + W , \qquad ( 1 )$$

where rₖ^{T} is the transposition of rₖ and W is the additive noise.

In order to estimate CSI between the j-th Base Station and the k-th terminal, located in the j-th cell, the j-th Base Station computes the vector:

yⱼ^{[k]}=Zⱼrₖ (2)

and further computes the minimum mean square error (MMSE) estimate of the channel vector gⱼ^{[kj]} as

$${\hat{g}}_{j}^{[ kj ]} = \frac{\sqrt{{ρ}_{r} τ} {β}_{j}^{ [ kj ]}}{{σ}^{2} + {\sum }_{l = 1}^{L} {ρ}_{r} τ {β}_{j}^{ [ kl ]}} {y}_{j}^{ [ k ]} ,$$

where σ² is the variance of the additive noise.

The estimation error is defined by

\tilde{g}ⱼ^{[kl]}=gⱼ^{[kl]}−ĝⱼ^{[kl]}.

Typically, the j-th base station transmits signals s^{[kj]}, k=1, . . . , K, for the K-th terminal located in the j-th cell. However, in accordance with an embodiment, the j-th base station instead transmits signals including a slow-fading precoding coefficient aⱼ^{[kl]} such that

$${c}_{j}^{[ k ]} = {\sum }_{l = 1}^{L} {a}_{j}^{[ kl ]} {s}^{[ kl ]} , k = 1 , … , K .$$

where the slow-fading precoding coefficient aⱼ^{[kl]} is a function of the slow-fading coefficients βⱼ^{[kl]}.

As such, the j-th base station can account for the slow-fading characteristics of interference signals between all base stations and terminals by optimizing the slow-fading precoding coefficient aⱼ^{[kl]}, where cⱼ^{[k]} is a function of all s^{[kl]}.

If an optimal slow-fading precoding coefficient aⱼ^{[kl]} is found, the j-th base station can form a 1×M vector

$${w}_{j} = {\sum }_{k = 1}^{K} {c}_{j}^{k} {y}_{j}^{{[ k ]}^{*}} ,$$

and transmit the components of wⱼ=(w₁ⱼ, w₂ⱼ, . . . , w_{Mj})from the corresponding antennas. This is known as conjugate precoding. One skilled in the art will note that conjugate precoding depends on fast-fading coefficients. Indeed, the vectors yⱼ^{[k]}, and further wⱼ depend on fast-fading coefficients, which are available locally at the j-th base station. As such, no exchange of fast fading coefficients between base stations is required.

As described above, determining the slow-fading precoding coefficient aⱼ^{[kl]} requires an exchange of only slow-fading coefficients between base stations. At the same time the conjugate beam-forming depends on only locally known fast-fading coefficients, which are available to each base station.

Each variable is defined or known in the process described above except for an optimal value for the slow-fading precoding coefficient aⱼ^{[kl]}. In determining an optimal slow-fading precoding coefficient aⱼ^{[kl]}, it is helpful to have an understanding of the signals received by terminals from base stations. For example, the k-th terminal in the l-th cell receives

$$\begin{matrix}{y}^{[ kl ]} = \frac{\sqrt{{ρ}_{f}}}{\sqrt{γ}} {\sum }_{j = 1}^{L} {w}_{j} {g}_{j}^{[ kl ]} \\ = \frac{\sqrt{{ρ}_{f}}}{\sqrt{γ}} {\sum }_{j = 1}^{L} {{\sum }_{n = 1}}^{K} {\sum }_{v = 1}^{L} {y}_{j}^{{[ n ]}^{*}} {g}_{j}^{[ kl ]} {a}_{j}^{[ nv ]} {s}^{[ nv ]} + additive noise ,\end{matrix}$$

where γ is a power normalization factor. The above expression can be simplified to be represented by an expression of the form

$${y}^{[ kl ]} = {n}_{0}^{[ kl ]} {s}^{[ kl ]} + {n}_{1}^{[ kl ]} + {n}_{2}^{[ kl ]} + {n}_{3}^{[ kl ]} + {n}_{4}^{[ kl ]} + additive noise , \\ where$$

$${n}_{0}^{[ kl ]} = \frac{\sqrt{{ρ}_{f}}}{\sqrt{γ}} {\sum }_{j = 1}^{L} E [ {y}_{j}^{{[ k ]}^{*}} {\hat{g}}_{j}^{[ kl ]} ] {a}_{j}^{[ kl ]}$$

$${n}_{1}^{[ kl ]} = \frac{\sqrt{{ρ}_{f}}}{\sqrt{γ}} {\sum }_{j = 1}^{L} {\sum }_{v \neq l}^{L} E [ {y}_{j}^{{[ k ]}^{*}} {\hat{g}}_{j}^{[ kl ]} ] {a}_{j}^{[ kv ]} {s}^{[ kv ]}$$

$${n}_{2}^{[ kl ]} = \frac{\sqrt{{ρ}_{f}}}{\sqrt{γ}} {\sum }_{j = 1}^{L} {\sum }_{n = 1}^{K} {y}_{j}^{{[ n ]}^{*}} {c}_{j}^{[ n ]} {\tilde{g}}_{j}^{[ kl ]}$$

$${n}_{3}^{[ kl ]} = \frac{\sqrt{{ρ}_{f}}}{\sqrt{γ}} {\sum }_{j = 1}^{L} {\sum }_{n = 1 , n \neq k}^{K} {y}_{j}^{{[ n ]}^{*}} {c}_{j}^{[ n ]} {\hat{g}}_{j}^{[ kl ]}$$

$${n}_{4}^{[ kl ]} = \frac{\sqrt{{ρ}_{f}}}{\sqrt{γ}} {\sum }_{j = 1}^{L} ( {y}_{j}^{{[ k ]}^{*}} {\hat{g}}_{j}^{[ kl ]} - E [ {y}_{j}^{{[ k ]}^{*}} {\hat{g}}_{j}^{[ kl ]} ] ) {c}_{j}^{[ k ]}$$

The interference terms n₁^{[kl]}, n₂^{[k1]}, n₃^{[k1]}, n₄^{[kl]} correspond to the issues related to TDD networks discussed above. In particular, n₁^{[kl]} is directed inter-cell interference caused by pilot contamination, n₂^{[kl]} is directed to channel estimation error, n₃^{[kl]} is directed to non-orthogonality of channel vectors, and n₄^{[kl]} is directed to beam-forming gain uncertainty at terminals.

As such, after additional simplifications to the computations (that will be understood by those skilled in the art), it follows that the SINR value of the k-th terminal in the l-th cell is

$${SINR}^{[ kl ]} = \frac{E [ {\vert {n}_{0}^{[ kl ]} \vert}^{2} ]}{{σ}^{2} + E [ {\vert {n}_{1}^{[ kl ]} \vert}^{2} + {\vert {n}_{2}^{[ kl ]} \vert}^{2} + {\vert {n}_{3}^{[ kl ]} \vert}^{2} ] + E [ {\vert {n}_{4}^{[ kl ]} \vert}^{2} ]} \qquad ( 3 )$$

Notably, the coefficients aⱼ^{[kv]}, directly or indirectly, affect the enumerator (E[|n₀^{[kl]}|²]) and all terms in the denominator (σ²E[|n₁^{[kl]}|²+|n₂^{[kl]}|²+|n₂^{[kl]}|²]+E[|n₄^{[kl]}|²). Thus, to achieve a feasible SINR (i.e., an SINR for which a successful signal transmission is possible) an optimal aⱼ^{[kv]} must be found such that the slow-fading precoding coefficient makes the denominator small, and at the same time makes the enumerator as large as possible. As such, an optimization function for finding an optimal slow-fading precoding coefficient aⱼ^{[kv]} can be formulated as:

$${max}_{{a}_{j}^{[ kv ]} ∈ R} {min}_{k \cdot l} log ( 1 + {SINR}^{[ kl ]} ) , \qquad ( 4 )$$

which is equivalent to the quasi-convex optimization function

$$SINR {max}_{{a}_{j}^{[ kv ]} ∈ R} {min}_{k \cdot l} {SINR}^{[ kl ]} . \qquad ( 5 )$$

In an embodiment, base station j 300 employs an iterative function to determine an optimized slow-fading precoding coefficient aⱼ^{[kv]}. In particular, base station j 300 may employ a quasi-convex optimization function to determines SINR_{inf}⁽⁰⁾, an SINR value for which the quasi-convex optimization function does not have a feasible slow-fading precoding coefficient aⱼ^{[kv]}, and SINR_{fea}⁽⁰⁾, an SINR value for which there exists a feasible slow-fading precoding coefficient aⱼ^{[kv]}. One skilled in the art will also note that the example quasi-convex optimization function is for illustrative purposes only, and that a variety of other iterative-type functions also may be employed by base station j to determine an optimized slow-fading precoding coefficient aⱼ^{[kv]}.

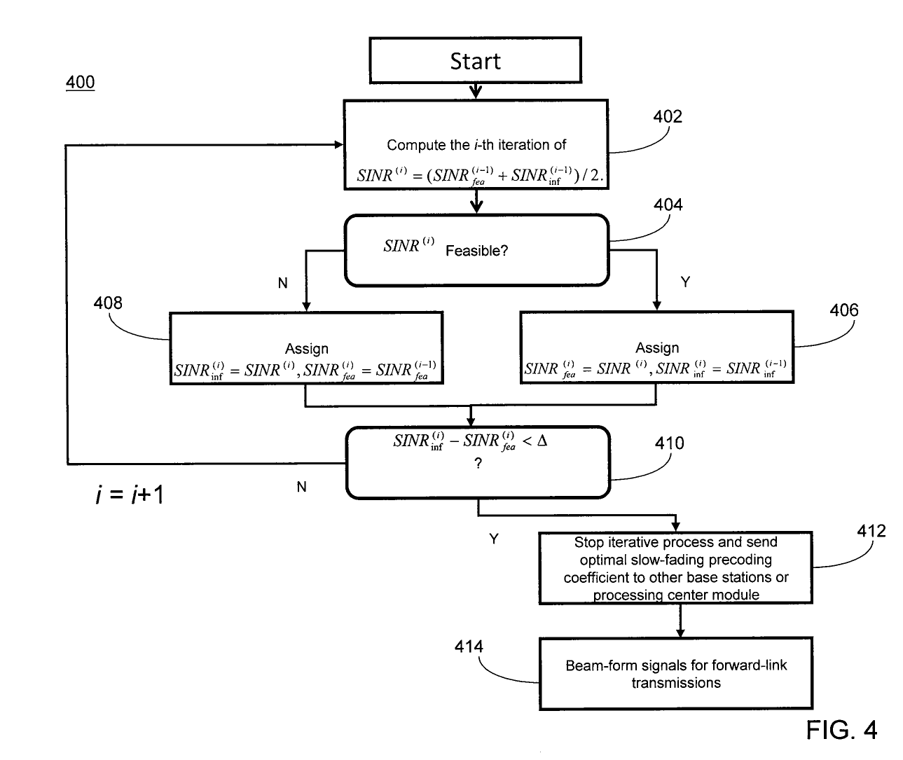

The preceding discussion is summarized in FIG. 4, to which we now turn. FIG. 4 illustrates a flow diagram for determining an optimal slow-fading precoding coefficient aⱼ^{[kv]} in accordance with an embodiment. The figure illustrates one possible procedure for processing the forward-link signals, which is meant to be exemplary and not limiting. Each base station in the network carries out the procedure illustrated in the figure. The figure is directed to the steps of the procedure as performed by one representative base station, namely base station j 300.

As such, base station j 300 computes the i-th iteration of SINR⁽ⁱ⁾=(SINR_{fea}⁽ⁱ⁻¹⁾+SINR_{inf}⁽ⁱ⁻¹⁾)/2. at 402. Base station j 300 then determines the feasibility of SINR⁽ⁱ⁾ at 404. For example, base station j 300 may perform a semi-definite programming procedure to determine the feasibility of SINR⁽ⁱ⁾. If SINR⁽ⁱ⁾ is feasible, at 406 base station j 300 assigns SINR_{fea}⁽ⁱ⁾=SINR⁽ⁱ⁾, SINR_{inf}⁽ⁱ⁾=SINR_{inf}^{i 1)}. Otherwise, base station j 300 assigns SINR_{inf}⁽ⁱ⁾=SINR⁽ⁱ⁾, SINR_{fea}⁽ⁱ⁾=SINR_{fea}ⁱ⁻¹⁾ at 408.

At 410, base station j 300 determines whether to stop the iterative process. If SINR_{inf}⁽ⁱ⁾−SINR_{fea}⁽ⁱ⁾<Δ, where Δ is a parameter to control the precision (i.e., a precision control threshold), base station j 300 stops the iterative process and sends the now optimal slow-fading precoding coefficient aⱼ^{[kv]} to one or more other base stations at 412. Alternatively, base station j 300 may send the optimal slow-fading precoding coefficient aⱼ^{[kv]} to a processing center module (e.g., for centralized distribution to other base stations).

At 414, base station j 300 may then beam-form signals for forward-link transmissions to one or more same-cell terminals based on the optimal slow-fading precoding coefficient aⱼ^{[kv]} selected to achieve SINR_{fea}⁽ⁱ⁾ (e.g., after obtaining pilot signals from each terminal). One exemplary but not limiting example for implementing a forward-link transmission is the approach that is described in Marzetta 2010. Another exemplary forward-link transmission approach is described in U.S. patent application Ser. No. 13/329,834, entitled “Large-Scale Antenna Method and Apparatus of Wireless Communication with Suppression of Intercell Interference”, which is incorporated herein by reference. If SINR_{inf}⁽ⁱ⁾−SINR_{fea}⁽ⁱ⁾≧Δ, base station j 300 continues the iterative process for the i+1-th iteration at 402.

Various of the mathematical computations described above, including the computation of the pilot contamination precoding matrix, may be performed by digital processors situated at individual base stations, or by digital processors situated at a central unit, or by a combination of digital processors situated in various ways. Without limitation, the digital processor may be any of general or special purpose digital computers, microprocessors, digital signal processors, or the like, acting under controls embodied in software, firmware, or hardware.

It will be understood that various approximations and alternative algorithms and mathematical formulations not explicitly described above may be used in implementations, without departing from the principles described above. Not least of these would be the setting of certain quantities, such as measured values of propagation coefficients, to zero if their values lie below an appropriate threshold.

It should also be understood that we have used the term “cell” in a broad sense to mean a cell, a sector, or any similar defined reception area within a wireless network.

Further, in various embodiments a base station may comprise one or more modules adapted for performing the features described herein. It should be understood in this regard that a module may be a specialized circuit or combination of circuits, or may be a set of instructions recorded in a machine-readable memory, together with general-purpose or special-purpose circuitry capable of carrying out the recorded instructions. In addition, one or more of the features described herein may be performed at nodes of the network that are distinct from the base stations, at several base stations (either individually or collectively), or at a combination of nodes and base stations.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 4, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

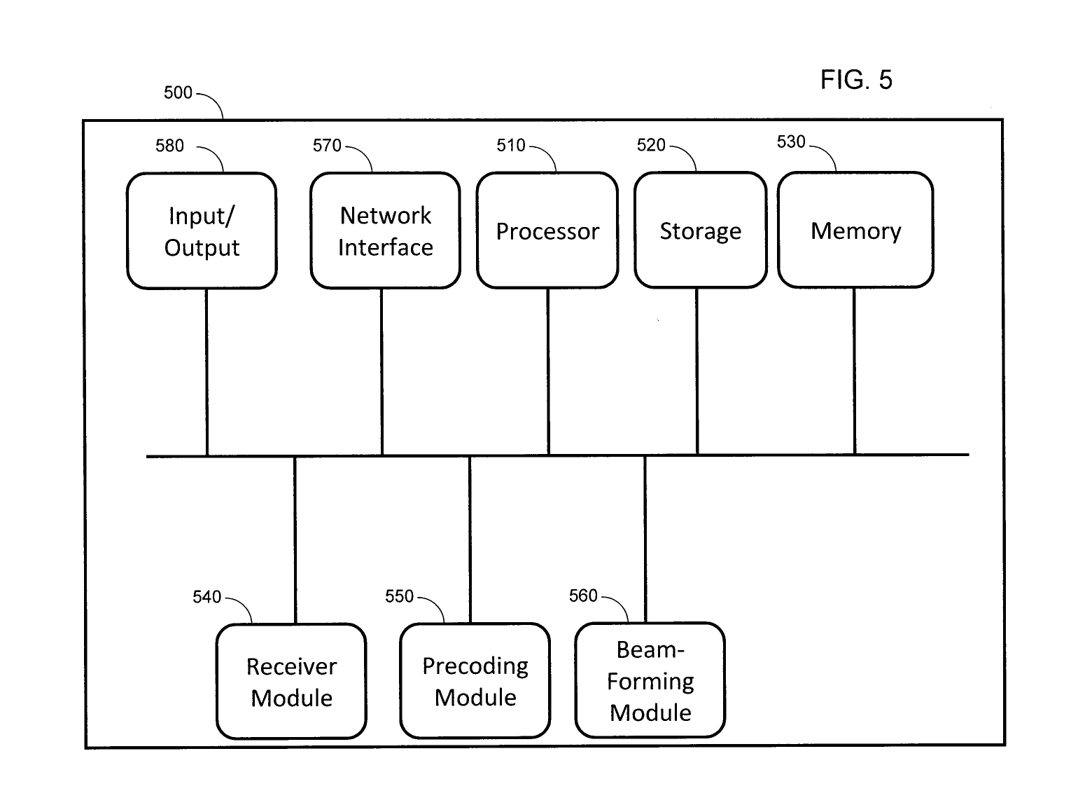

A high-level block diagram of an exemplary base station apparatus that may be used to implement systems, apparatus and methods described herein is illustrated in FIG. 5. Base station apparatus 500 comprises a processor 510 operatively coupled to a data storage device 520 and a memory 530. Processor 510 controls the overall operation of base station apparatus 500 by executing computer program instructions that define such operations. The computer program instructions may be stored in data storage device 520, or other computer-readable medium, and loaded into memory 530 when execution of the computer program instructions is desired. For example, receiver module 540 adapted for obtaining a plurality of slow-fading coefficients, precoding module 550 adapted for generating a set of slow-fading precoding coefficients, and beam-forming module 560 for transmitting signals to same-cell terminals may comprise one or more components of computer 500. Thus, the method steps of FIG. 4 can be defined by the computer program instructions stored in memory 530 and/or data storage device 520 and controlled by processor 510 executing the computer program instructions. For example, the computer program instructions can be implemented as computer executable code programmed by one skilled in the art to perform an algorithm defined by the method steps of FIG. 4. Accordingly, by executing the computer program instructions, the processor 510 executes an algorithm defined by the method steps of FIG. 4. Base station apparatus 500 also includes one or more network interfaces 570 for communicating with other devices via a network. Base station apparatus 500 may also include one or more input/output devices 580 that enable user interaction with base station apparatus 500 (e.g., display, keyboard, mouse, speakers, buttons, etc.).

Processor 510 may include both general and special purpose microprocessors, and may be the sole processor or one of multiple processors of base station apparatus 500. Processor 510 may comprise one or more central processing units (CPUs), for example. Processor 510, data storage device 520, and/or memory 530 may include, be supplemented by, or incorporated in, one or more application-specific integrated circuits (ASICs) and/or one or more field programmable gate arrays (FPGAs).

Data storage device 520 and memory 530 each comprise a tangible non-transitory computer readable storage medium. Data storage device 520, and memory 530, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 580 may include peripherals, such as a printer, scanner, display screen, etc. For example, input/output devices 580 may include a display device such as a cathode ray tube (CRT), plasma or liquid crystal display (LCD) monitor for displaying information to the user, a keyboard, and a pointing device such as a mouse or a trackball by which the user can provide input to base station apparatus 500.

Any or all of the systems and apparatus discussed herein, including receiver module 540, precoding module 550, and beam-forming module 560 may be performed by a base station such as base station apparatus 500.

One skilled in the art will recognize that an implementation of an actual computer or computer system may have other structures and may contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. A method performed by a base station of a cellular network, the base station serving pluralities of same-cell terminals and other-cell terminals, and the cellular network including other base stations that serve respective pluralities of same-cell terminals and other-cell terminals, the method comprising:
receiving a plurality of slow-fading coefficients, each of the plurality of slow-fading coefficients being associated with channel state information for communication between one of the other base stations and one of the respective same-cell terminals or other-cell terminals; and
generating a set of slow-fading precoding coefficients for transmitting signals to same-cell terminals and other-cell terminals based on the plurality of slow-fading coefficients.

2. The method of claim 1 wherein generating the set of slow-fading precoding coefficients comprises performing an iterative function to determine optimized slow-fading precoding coefficients.

3. The method of claim 2 wherein each optimized slow-fading precoding coefficient is determined based on maximizing a minimum signal to interference and noise ratio for transmitting a signal to same-cell terminals and other-cell terminals.

4. The method of claim 2 further comprising terminating the iterative function based on a precision control threshold.

5. The method of claim 2 wherein the iterative function includes a quasi-convex optimization algorithm.

6. The method of claim 1 further comprising:
obtaining pilot signals from the plurality of terminals; and
beam-forming signals to one or more of the plurality of same-cell terminals and other-cell terminals based on the set of slow-fading precoding coefficients.

7. The method of claim 6 wherein the beam-forming is based on a set of fast-fading coefficients.

8. The method of claim 6 wherein the beam-forming is performed using OFDM modulation.

9. The method of claim 1 further comprising transmitting the set of slow-fading precoding coefficients to one of the other base stations.

10. The method of claim 1 further comprising transmitting the set of slow-fading precoding coefficients to a processing center module.

11. A base station apparatus for serving pluralities of same-cell terminals and other-cell terminals in a cellular network, the base station apparatus comprising:
a receiver module adapted for obtaining a plurality of slow-fading coefficients, each of the plurality of slow-fading coefficients being associated with channel state information for communication between another base station and one of a plurality of same-cell terminals or other-cell terminals; and
a precoding module adapted for generating a set of slow-fading precoding coefficients for transmitting signals to same-cell terminals and other-cell terminals based on the plurality of slow-fading coefficients.

12. The base station apparatus of claim 11 wherein generating the set of slow-fading precoding coefficients comprises performing an iterative function to determine optimized slow-fading precoding coefficients.

13. The base station apparatus of claim 12 wherein each optimized slow-fading precoding coefficient is determined based on maximization of a minimum signal to interference and noise ratio for transmitting a signal to a same-cell terminals and other-cell terminals.

14. The base station apparatus of claim 12 wherein the precoding module is further adapted for terminating the iterative function based on a precision control threshold.

15. The base station apparatus of claim 12 wherein the iterative function includes a quasi-convex optimization algorithm.

16. The base station apparatus of claim 11 further comprising:
the receiver module adapted for obtaining pilot signals from the plurality of terminals; and
a beam-forming module adapted for beam-forming signals to one or more of the plurality of same-cell terminals and other-cell terminals based on the set of slow-fading precoding coefficients.

17. The base station apparatus of claim 16 wherein the beam-forming is based on a set of fast-fading coefficients.

18. The base station apparatus of claim 16, wherein the beam-forming is performed using OFDM modulation.

19. The base station apparatus of claim 11 further comprising a transmitter module adapted for transmitting the set of slow-fading precoding coefficients to one of the other base stations.

20. The base station apparatus of claim 11 further comprising a transmitter module adapted for transmitting the set of slow-fading precoding coefficients to a processing center module.
